(19) United States
(12) Patent Application Publication
(10) Pub. No.: US 2025/0192151 A1
(43) Pub. Date: Jun. 12, 2025

(54) COMPOSITE ANODE ACTIVE MATERIAL LAYER FOR ALL-SOLID-STATE-BATTERY AND MANUFACTURING METHOD THE SAME

(71) Applicants: Hyundai Motor Company, Seoul (KR); Kia Corporation, Seoul (KR)

(72) Inventors: Jae Min Lim, Suwon-si (KR); Seon Hwa Kim, Cheongju-si (KR); Hee Soo Kang, Seoul (KR); Dong Hyun Cho, Hwaseong-si (KR); Jae Seok Nam, Suwon-si (KR); Hong Suk Choi, Hwaseong-si (KR); So Yeon Kim, Suwon-si (KR)

(21) Appl. No.: 18/732,050

(22) Filed: Jun. 3, 2024

(30) Foreign Application Priority Data
Dec. 6, 2023 (KR) 10-2023-0175084

(51) Int. Cl. H01M 4/36; H01M 4/02; H01M 4/04; H01M 4/1393; H01M 4/1395; H01M 4/38; H01M 4/587; H01M 4/62; H01M 10/0525; H01M 10/0562

(52) U.S. Cl. CPC H01M 4/366; H01M 4/0404; H01M 4/1393; H01M 4/1395; H01M 4/386; H01M 4/587; H01M 4/62; H01M 10/0525; H01M 10/0562; H01M 2004/021; H01M 2004/027; H01M 2300/008

(57) ABSTRACT

In a composite anode active material layer for all-solid-state batteries, and a manufacturing method thereof at a temperature of 40° C. or lower, the ratio of Young's modulus or the ratio of lithium-ion conductivities of a solid electrolyte in the anode active material layer to a solid electrolyte included in a composite anode active material having a core-shell structure can be controlled within a range, and thereby, occurrence of interfacial cracks caused by expansion and contraction behavior of an anode during charging and discharging of a battery can be minimized and durability and output characteristics of the battery can be improved.

### CROSS-REFERENCE TO RELATED APPLICATIONS

This application claims the benefit of Korean Patent Application No. 10-2023-0175084, filed on Dec. 6, 2023, which application is hereby incorporated herein by reference.

### TECHNICAL FIELD

The present disclosure relates to a composite anode active material layer for all-solid-state batteries and a manufacturing method thereof.

### BACKGROUND

Recently, to solve environmental problems caused by carbon dioxide (CO₂), use of fossil fuels has been avoided, and thus, the automobile industry, which relates to means of transportation, is showing great interest in electric vehicles using secondary batteries. Using currently developed lithium-ion batteries, vehicles may travel about 40 km on a single charge, but problems, such as instability at high temperatures and fire, still exist. To solve these problems, many companies are competitively developing next-generation secondary batteries.

All-solid-state batteries, which are attracting attention as next-generation secondary batteries, have advantages of lower risk of fire and explosion and higher mechanical strength compared to lithium-ion batteries that use flammable organic solvents as electrolytes because all components of the all-solid-state batteries are formed of solid. The all-solid-state battery generally includes a cathode active material layer bonded to a cathode current collector, an anode active material layer bonded to an anode current collector, and a solid electrolyte layer located between the cathode active material layer and the anode active material layer.

The anode active material layer is generally used in the form of a composite of an anode active material and a solid electrolyte to ensure lithium-ion conductivity in the anode active material layer. Lithium-ion conductivity varies depending on a degree and method of combining the anode active material and the solid electrolyte, and leads to differences in the output and durability characteristics of the battery.

All-solid-state batteries may use a variety of anode active materials compared to lithium-ion batteries, and recently, to achieve high energy density, research on replacement of existing graphite (˜375 mAh/g) with a high energy density material, such as silicon (˜3600 mAh/g) or lithium (˜3860 mAh/g), is actively underway.

There among, silicon has a volume change of close to 400% during a charging and discharging process, and as a charge and discharge cycle count increases, rapid capacity deterioration occurs due to loss of the contact surface between the silicon and the solid electrolyte that is present in the form of the composite in the anode active material layer, and thus, it is difficult to use a silicon-based active material alone.

The above information disclosed in this Background section is only for enhancement of understanding of the background of the present disclosure and therefore it may contain information that does not form the prior art that is already publicly known, available, or in use.

### SUMMARY

The present disclosure relates to a composite anode active material layer for all-solid-state batteries and a manufacturing method thereof. More particularly, the present disclosure relates to a composite anode active material layer for all-solid-state batteries and a manufacturing method thereof, in which the ratio of Young's modulus or the ratio of lithium-ion conductivities of a solid electrolyte in the anode active material layer to a solid electrolyte included in a composite anode active material having a core-shell structure is controlled within a selected or predetermined range, so that occurrence of interfacial cracks caused by expansion and contraction behavior an anode during charging and discharging of a battery may be minimized, and durability and output characteristics of the battery may be improved.

Some embodiments of the present disclosure can solve the above-described problems, and can improve the output and durability of a battery by coating the surface of a silicon-based active material with a solid electrolyte having high lithium-ion conductivity.

Because the volume of the silicon-based active material can vary greatly depending on charging and discharging of the battery, when charging and discharging of the battery is repeated, cracks or voids are formed at the interface between the solid electrolyte coated on the surface of the silicon-based active material and a solid electrolyte in an anode active material layer, and thus, interfacial resistance may be increased and a capacity expression rate may be decreased. Further, lithium can be irreversibly precipitated between the voids, and thereby, a discharge capacity may be reduced.

Some embodiments of the present disclosure can alleviate impact of volume changes occurring during charging and discharging of a battery by controlling a ratio of the Young's modulus of a solid electrolyte included in an anode active material layer to the Young's modulus of a solid electrolyte coated on the surface of an anode active material within a designated range.

Some embodiments of the present disclosure can suppress increases in interfacial resistance due to a difference in lithium-ion conductivity by controlling a ratio of the lithium-ion conductivity of a solid electrolyte included in an anode active material layer to the lithium-ion conductivity of a solid electrolyte coated on the surface of an anode active material within a designated range.

Advantages of the present disclosure are not necessarily limited to the above-mentioned advantages. Advantages provided by some embodiments of the present disclosure can become clearer from the following description, and may be realized according to the claims and combinations thereof.

In an embodiment of the present disclosure, an anode active material layer for all-solid-state batteries can include a composite anode active material having a core-shell structure, and a first solid electrolyte, where the composite anode active material includes cores including a silicon-based active material, and shells configured to coat at least a portion of a surface of the silicon-based active material and including a second solid electrolyte, where a ratio (E₁/E₂) of a Young's modulus (E₁) of the first solid electrolyte to a Young's modulus (E₂) of the second solid electrolyte satisfies 1.5≤E₁/E₂≤3.0.

In an embodiment of the present disclosure, a ratio (I₁/I₂) of lithium-ion conductivity (I₁) of the first solid electrolyte to lithium-ion conductivity (I₂) of the second solid electrolyte may satisfy 0.5≤I₁/I₂≤2.0.

In an embodiment of the present disclosure, the first solid electrolyte may include a sulfide-based solid electrolyte. Further, the second solid electrolyte may include a sulfide-based solid electrolyte.

In an embodiment of the present disclosure, the silicon-based active material may include at least one selected from the group consisting of silicon particles, silicon oxide, a silicon alloy, and combinations thereof.

In an embodiment of the present disclosure, the silicon-based active material may include a carbon-based material.

In an embodiment of the present disclosure, a manufacturing method of an anode active material layer for all-solid-state batteries can include synthesizing a composite anode active material by putting an anode active material and a second solid electrolyte into a mixer and then mixing the anode active material and the second solid electrolyte, preparing an anode active material slurry by mixing the composite anode active material and a first solid electrolyte, and forming the anode active material layer by applying the anode active material slurry to an anode current collector and then drying the anode active material slurry.

In an embodiment of the present disclosure, the anode active material and the second solid electrolyte may be mixed for 2 minutes to 15 minutes. A temperature of the composite anode active material after mixing the anode active material and the second solid electrolyte may be 40° C. or lower.

In an embodiment of the present disclosure, the mixer may include a resonant acoustic mixer (RAM).

In an embodiment of the present disclosure, the anode active material and the second solid electrolyte may be put into the mixer in a weight ratio of 10:1 to 7:3.

### BRIEF DESCRIPTION OF THE DRAWINGS

The above and other features of the present disclosure will now be described in detail with reference to certain example embodiments thereof illustrated in the accompanying drawings given by way of illustration only, and thus are not necessarily limitative of the present disclosure, and in which:

FIG. 1 is a view schematically illustrating an anode active material layer according to an embodiment of the present disclosure;

FIG. 2 is a view schematically illustrating a composite anode active material and a first solid electrolyte surrounding the composite anode active material according to an embodiment of the present disclosure;

FIG. 3 shows Young's modulus measurement results of argyrodite-type sulfide-based solid electrolytes having various halogen contents, according to an embodiment of the present disclosure;

FIG. 4 is a photograph of a composite anode active material according to Preparation Example 1 taken with a scanning electron microscope (SEM), according to an embodiment of the present disclosure;

FIG. 5 shows analysis results of sulfur (S) included in the composite anode active material of FIG. 4 using energy dispersive spectroscopy (EDS), according to an embodiment of the present disclosure;

FIG. 6 shows analysis results of silicon (Si) included in the composite anode active material of FIG. 4 using energy dispersive spectroscopy (EDS), according to an embodiment of the present disclosure;

FIG. 7 is a graph showing results of durability evaluation conducted by performing charging and discharging of compressed batteries according to Examples and Comparative Examples, according to an embodiment of the present disclosure;

FIG. 8 is a photograph of the cross-section of an anode active material layer according to Example 1 taken with the scanning electron microscope (SEM), after durability evaluation, according to an embodiment of the present disclosure;

FIG. 9 is a photograph of the cross-section of an anode active material layer according to Comparative Example 4 taken with the scanning electron microscope (SEM), after durability evaluation, according to an embodiment of the present disclosure; and

FIG. 10 is a graph showing results of charge/discharge evaluation on the compressed batteries according to Example 1, Comparative Example 5, and Comparative Example 6, according to an embodiment of the present disclosure.

It can be understood that the appended drawings are not necessarily to scale, can present a somewhat simplified representation of various features illustrative of some embodiments of the present disclosure. The specific design features of an embodiment of the present disclosure as disclosed herein, including, for example, specific dimensions, orientations, locations, and shapes, can be determined in part by the particular intended application and use environment.

In the figures, reference numbers can refer to the same or equivalent parts of the present disclosure throughout the several figures of the drawing.

### DETAILED DESCRIPTION OF ILLUSTRATIVE EMBODIMENTS

The above-described advantages and features of the present disclosure can become apparent from the descriptions of example embodiments given hereinbelow with reference to the accompanying drawings. However, the present disclosure is not necessarily limited to the example embodiments disclosed herein and may be implemented in various different forms and variations thereof. The example embodiments are provided to make the description of the present disclosure thorough and to fully convey the scope of the present disclosure to those skilled in the art.

In the accompanying drawings, the dimensions of structures may be exaggerated compared to the actual dimensions thereof, for clarity of description. In the following description, terms, such as “first” and “second”, may be used to describe various elements but do not necessarily limit the elements. Such terms can be used merely to distinguish one element from other elements. For example, a first element may be named a second element, and similarly, a second element may be named a first element, without departing from the scope and spirit of the disclosure. Singular expressions may encompass plural expressions, unless they have clearly different contextual meanings.

In the following description of the embodiments, terms, such as “including”, “comprising” and “having”, can be interpreted as indicating the presence of characteristics, numbers, steps, operations, elements, or parts stated in the description or combinations thereof, and do not exclude the presence of one or more other characteristics, numbers, steps, operations, elements, parts, or combinations thereof, or possibility of adding the same. In addition, it can be understood that, when a part, such as a layer, a film, a region or a plate, is said to be “on” another part, the part may be located “directly on” the other part or other parts may be interposed between the two parts. In the same manner, it can be understood that, when a part, such as a layer, a film, a region or a plate, is said to be “under” another part, the part may be located “directly under” the other part or other parts may be interposed between the two parts.

All numbers, values, and/or expressions representing amounts of components, reaction conditions, polymer compositions, and blends used in the description are approximations in which various uncertainties in measurement generated when these values are obtained from essentially different things are reflected and thus it can be understood that they can be modified by the term “about”, unless stated otherwise. In addition, it can be understood that, if a numerical range is disclosed in the description, such a range can include all continuous values from a minimum value to a maximum value of the range, unless stated otherwise. Further, if such a range refers to integers, the range can include all integers from a minimum integer to a maximum integer, unless stated otherwise.

In the following description of example embodiments, it can be understood that, when the range of a variable is stated, the variable can include all values within the stated range including stated end points of the range. For example, it can be understood that a range of “5 to 10” includes not only values of 5, 6, 7, 8, 9 and 10 but also arbitrary subranges, such as a subrange of 6 to 10, a subrange of 7 to 10, a subrange of 6 to 9, and a subrange of 7 to 9, and arbitrary values between integers which are valid within the scope of the stated range, such as 5.5, 6.5, 7.5, 5.5 to 8.5, and 6.5 to 9. Further, for example, it can be understood that a range of “10% to 30%” includes not only all integers including values of 10%, 11%, 12%, 13%, . . . 30% but also arbitrary subranges, such as a subrange of 10% to 15%, a subrange of 12% to 18%, and a subrange of 20% to 30%, and arbitrary values between integers which are valid within the scope of the stated range, such as 10.5%, 15.5%, and 25.5%.

### Anode Active Material Layer for All-Solid-State Batteries

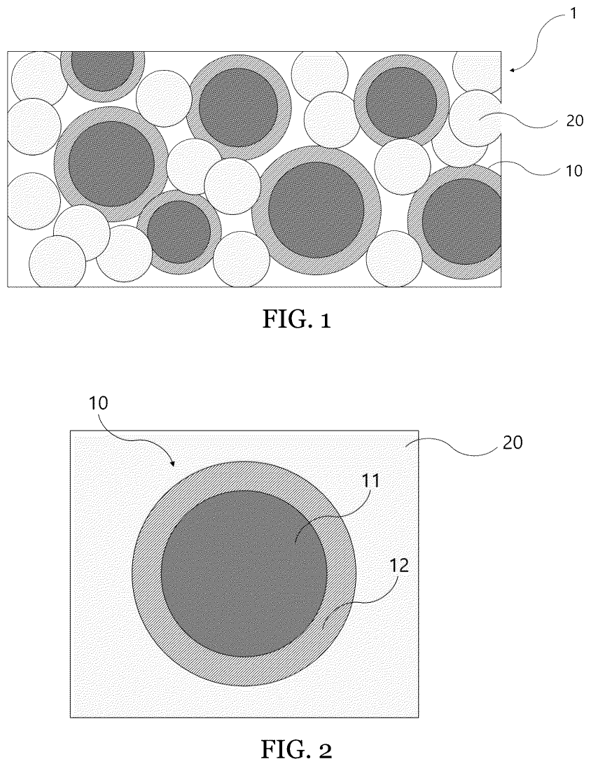

FIG. 1 is a view schematically illustrating an anode active material layer 1 according to an embodiment of the present disclosure. Referring to FIG. 1, the anode active material layer 1 according to an embodiment of the present disclosure may include a composite anode active material 10 having a core-shell structure, and a first solid electrolyte 20.

When a general all-solid-state battery is charged, lithium ions (Li⁺) are emitted from a cathode active material layer and migrate to the anode active material layer 1 along a solid electrolyte layer. The lithium ions (Li⁺) migrated to the anode active material layer 1 may be stored in an anode active material or on the surface of the anode active material. When the anode active material layer 1 includes the first solid electrolyte 20 having high lithium-ion conductivity as in the present disclosure, the lithium ions (Li⁺) may be easily moved and stored in the anode active material layer 1.

The first solid electrolyte 20 can be included in the anode active material layer 1, and may include a solid electrolyte having high lithium-ion conductivity.

The first solid electrolyte 20 may include an oxide-based solid electrolyte, a sulfide-based solid electrolyte, or the like. In an embodiment, a sulfide-based solid electrolyte having high lithium-ion conductivity may be used as the first solid electrolyte 20. For example, an argyrodite-type sulfide-based solid electrolyte may be used.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—LiₓMO_{y} (x and y being positive numbers, and M being one of P, Si, Ge, B, Al, Ga and In), Li₁₀GeP₂S₁₂, or the like, for example, without being particularly limited.

If other conditions are the same, the Young's modulus of the sulfide-based solid electrolyte may decrease as the content of a halogen element in the sulfide-based solid electrolyte increases.

The oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), or the like, for example.

FIG. 2 is a view schematically illustrating the composite anode active material 10 and the first solid electrolyte 20 surrounding the composite anode active material 10 according to an embodiment of the present disclosure. In FIG. 2, the first solid electrolyte 20 is shown in an appropriately simplified manner. The composite anode active material 10 may include cores including a silicon-based active material 11, and shells configured to coat at least a portion of the surface of the silicon-based active material 11 and including a second solid electrolyte 12.

The silicon-based active material 11 may use any material as long as it has a higher theoretical capacity than conventional graphite-based anode active materials and includes silicon, for example, without being particularly limited. For example, the silicon-based active material 11 may include at least one selected from the group consisting of silicon particles, silicon oxide, a silicon alloy, and combinations thereof.

Further, the silicon-based active material 11 may be a composite including a carbon-based material. For example, the silicon-based active material 11 may be a composite formed by coating at least a portion of the surfaces of the silicon particles, silicon oxide or silicon alloy with the carbon-based material. Alternatively, the silicon-based active material 11 may be a composite formed by coating at least a portion of the surface of the carbon-based material with the silicon particles, silicon oxide or silicon alloy. The silicon-based active material 11 may be a composite in which primary particles respectively formed of the silicon particles, silicon oxide or silicon alloy, and the carbon-based material aggregate to form secondary particles.

In the composite anode active material, the cores can be formed of the silicon-based active material 11 so as to secure a high theoretical capacity, and at least a portion of the surface of the silicon-based active material 11 can be coated with the second solid electrolyte 12 having high lithium-ion conductivity, and thus, storage and release of lithium ions may be facilitated when charging and discharging a battery.

The second solid electrolyte 12 can coat at least a portion of the surface of the silicon-based active material 11, and may include a solid electrolyte having high lithium-ion conductivity.

The second solid electrolyte 12 may include an oxide-based solid electrolyte, a sulfide-based solid electrolyte, or the like. In an embodiment, a sulfide-based solid electrolyte having high lithium-ion conductivity may be used as the second solid electrolyte 12. For example, an argyrodite-type sulfide-based solid electrolyte may be used.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—LiₓMO_{y} (x and y being positive numbers, and M being one of P, Si, Ge, B, Al, Ga and In), Li₁₀GeP₂S₁₂, or the like, for example, without being particularly limited.

If other conditions are the same, the Young's modulus of the sulfide-based solid electrolyte may decrease as the content of a halogen element in the sulfide-based solid electrolyte increases.

The first solid electrolyte 20 and the second solid electrolyte 12 may be the same or different from each other.

The anode active material layer 1 for all-solid-state batteries according to an embodiment of the present disclosure may be configured such that the ratio E₁/E₂ of the Young's modulus E₁ of the first solid electrolyte 20 to the Young's modulus E₂ of the second solid electrolyte 12 may satisfy 1.5≤E₁/E₂≤3.0.

The Young's modulus E is a modulus indicating how the relative length of an elastic object changes with respect to stress, a lower value of the Young's modulus indicates lower stiffness, and a larger value of the Young's modulus indicates higher stiffness.

The Young's modulus is the generalization of a modulus in Hooke's law for an elastic object, but typically has no relation to the processed shape (for isotropic materials) of the object and may be affected only by the inherent mechanical properties of a material constituting the object. Therefore, when measuring the Young's modulus of the first solid electrolyte 20 and the Young's modulus of the second solid electrolyte 12, there is not necessarily a need to measure the respective values of the Young's modulus of the first and second solid electrolytes 20 and 12 after manufacturing the first and second solid electrolytes 20 and 12 in a form included in the anode active material 10 or the anode active material layer 1, and the Young's modulus of the first and second solid electrolytes 20 and 12 may be measured after processing the first and second solid electrolytes 20 and 12 into the form of specimens, Young's modulus of which are easy to measure.

The Young's modulus of a solid electrolyte may vary depending on the type of a halogen element with which the solid electrolyte is doped, the content of the halogen element, a degree of crystallinity, and the like. Specifically, the higher the content of the halogen element with which the solid electrolyte is doped, the lower the Young's modulus. In addition, as the degree of crystallinity of the solid electrolyte increases, the Young's modulus thereof may increase. In general, the degree of crystallinity of the solid electrolyte may increase as the amount of heat applied to raw materials in the process of manufacturing the solid electrolyte increases, i.e., a firing temperature raises and a firing time increases.

When the ratio E₁/E₂ of the Young's modulus E₁ of the first solid electrolyte 20 to the Young's modulus E₂ of the second solid electrolyte 12 according to an embodiment of the present disclosure satisfies 1.5≤E₁/E₂≤3.0, this may mean that the stiffness of the first solid electrolyte 20 is higher than the stiffness of the second solid electrolyte 12. Accordingly, when the volume of the second solid electrolyte 12 increases or decreases in response to a change in the volume of the silicon-based active material 11, the first solid electrolyte 20 may suppress expansion of the second solid electrolyte 12.

When the ratio E₁/E₂ of the Young's modulus E₁ of the first solid electrolyte 20 to the Young's modulus E₂ of the second solid electrolyte 12 is less than 1.5, this may indicate that the Young's modulus E₁ of the first solid electrolyte 20 is high and thus elasticity of the shells is low, or the Young's modulus E₂ of the second solid electrolyte 12 is low and thus the stiffness thereof is low. Accordingly, the composite anode active material 10 can lack mechanical properties to suppress expansion thereof, and when charging and discharging are repeated, cracks can occur at the interface between the first solid electrolyte 20 and the second solid electrolyte 12, and thus, cycle life characteristics and output characteristics of the battery may be deteriorated.

When the ratio E₁/E₂ of the Young's modulus E₁ of the first solid electrolyte 20 to the Young's modulus E₂ of the second solid electrolyte 12 exceeds 3, a difference in stiffness between the first solid electrolyte 20 and the second solid electrolyte 12 can be too large and thus a degree of formation of the interface therebetween can be reduced, and internal resistance may be increased accordingly.

Because the Young's modulus E₁ of the first solid electrolyte 20 and the Young's modulus E₂ of the second solid electrolyte 12 may be influenced not only by the compositions thereof but also by crystal structures, crystal sizes, and the like, to satisfy the above-described ratio E₁/E₂ of the Young's modulus E₁ of the first solid electrolyte 20 to the Young's modulus E₂ of the second solid electrolyte 12, the first solid electrolyte 20 and the second solid electrolyte 12 do not necessarily need to be different.

In an embodiment, the ratio I₁/I₂ of the lithium-ion conductivity I₁ of the first solid electrolyte 20 to the lithium-ion conductivity I₂ of the second solid electrolyte 12 may satisfy 0.5≤I₁/I₂≤2.0.

When the ratio I₁/I₂ of the lithium-ion conductivity I₁ of the first solid electrolyte 20 to the lithium-ion conductivity I₂ of the second solid electrolyte 12 is outside the above range, interfacial resistance between the first solid electrolyte 20 and the second solid electrolyte 12 can occur, and thus, the effect of improving the output characteristics of the battery may be reduced.

In relation to this, the lithium-ion conductivity of a solid electrolyte may vary depending on the composition of the solid electrolyte, a dopant, a crystal structure, a degree of crystallinity, a lithium-ion conduction path formed in the solid electrolyte, and the like. For example, the lithium-ion conductivity of the solid electrolyte may be improved as the degree of crystallinity of the solid electrolyte increases. In general, the degree of crystallinity of the solid electrolyte may increase as the amount of heat applied to raw materials in the process of manufacturing the solid electrolyte increases, i.e., the firing temperature rises and the firing time increases.

In the anode active material layer 1 for all-solid-state batteries according to an embodiment of the present disclosure, it may be desirable that the ratio E₁/E₂ of the Young's modulus E of the first solid electrolyte 20 to the Young's modulus E₂ of the second solid electrolyte 12 satisfies 1.5≤E₁/E₂≤3.0, and the ratio I₁/I₂ of the lithium-ion conductivity I₁ of the first solid electrolyte 20 to the lithium-ion conductivity I₂ of the second solid electrolyte 12 satisfies 0.5≤I₁/I₂≤2.0, simultaneously. Accordingly, occurrence of cracks and increase in interfacial resistance at the interface between the first solid electrolyte 20 and the second solid electrolyte 12 when the volume of the anode active material layer 1 is changed due to charging and discharging of the battery may be suppressed, and the durability and output characteristics of the battery may be improved.

Hereinafter, a manufacturing method of the anode active material layer 1 for all-solid-state batteries according to an embodiment of the present disclosure will be described in detail.

### Manufacturing Method of Anode Active Material Layer for All-Solid-State Batteries

A manufacturing method of the anode active material layer 1 for all-solid-state batteries according to an embodiment of the present disclosure may include synthesizing the composite anode active material 10 by putting the anode active material and the second solid electrolyte 12 into a mixer and then mixing the same, preparing an anode active material slurry by mixing the composite anode active material 10 and the first solid electrolyte 20, and forming the anode active material layer 1 by applying the anode active material slurry to an anode current collector and drying the anode active material slurry.

The anode active material can be substantially the same as the above-described anode active material, and may include a silicon-based active material or may further include a carbon-based material.

In general, methods of manufacturing the composite anode active material 10 having a core-shell structure by coating at least a portion of the surface of the silicon-based active material with a solid electrolyte can be divided into a wet method in which a solution is prepared by dissolving a solid electrolyte in a solvent and then the surface of an anode active material is coated with the solution, and a dry method in which an anode active material and solid electrolyte raw materials are pulverized using a paint shaker or a Thinky mixer and then the surface of the anode active material is coated with the solid electrolyte.

The wet method can require heat treatment at a high temperature of 300° C. or higher after coating the surface of the anode active material with the solid electrolyte, and after synthesizing the composite anode active material 10 though the paint shaker, the temperature of the composite anode active material 10 may be raised to about 80° C. to 100° C. Further, after synthesizing the composite anode active material 10 though the Thinky mixer, the temperature of the composite anode active material 10 may be raised to about 50° C. to 60° C.

However, when the composite anode active material 10 synthesized by the wet method or after mixing using the mixer, such as the paint shaker or the Thinky mixer, exceeds 40° C., a side reaction between carbon included in the anode active material and the solid electrolyte can be promoted and deterioration of the anode active material may occur.

Accordingly, as the mixer according to an embodiment of the present disclosure, a mixer that may lower the temperature of the composite anode active material 10 to 40° C. or lower after mixing may be used. For example, for process efficiency, a mixer capable of manufacturing the composite anode active material 10 by performing mixing for 2 to 15 minutes may be used.

In a manufacturing method according to an embodiment of the present disclosure, the composite anode active material 10 may be manufactured by putting the anode active material and the second solid electrolyte 12 into a resonant acoustic mixer (RAM) and then mixing the same.

The resonant acoustic mixer is equipment that disperses, crushes, or coats particles of a mixture by efficiently transferring energy to the mixture using a resonance phenomenon. Specifically, the mixture may be induced into an acoustic resonance state using a resonant acoustic frequency that may refine the sizes of the particles constituting the mixture, and at this time, acoustic energy including the resonant acoustic frequency may accumulate in the particles constituting the mixture and inherently disperse the particles into a structure or a surrounding medium.

In a manufacturing method according to an embodiment of the present disclosure, the resonant acoustic mixer having better energy transfer efficiency than the conventional paint shaker or Thinky mixer can be used, and thus, the temperature of the composite anode active material 10 after mixing may become 25° C. to 40° C. Further, mixing through the resonant acoustic mixer can be performed for 2 to 15 minutes, which may be much shorter than in the conventional wet and dry methods.

Furthermore, at least one of the steps for synthesizing a composite anode active material, preparing an anode active material slurry, and forming an anode active material layer may be performed at a temperature of 40° C. or lower.

In a manufacturing method according to an embodiment of the present disclosure, the composite anode active material 10 can be manufactured using the resonant acoustic mixer at a lower temperature than other manufacturing methods, thereby being capable of suppressing a side reaction between carbon included in the silicon-based active material and the solid electrolyte. In addition, mixing may be performed for a shorter time than other manufacturing methods, thereby being capable of improve process efficiency.

Although the resonant acoustic mixer has been described as an example of a mixer used in the present disclosure, any mixer capable of lowing the temperature of the composite anode active material 10 after mixing to 40° C. or lower may be used without being particularly limited. For example, a mixer capable of preparing a composite anode active material by performing mixing for 2 to 15 minutes may be used.

In an embodiment, the anode active material and the second solid electrolyte 12 may be put into the resonant acoustic mixer in a weight ratio of 10:1 to 7:3. When a larger amount of the anode active material beyond the above range is put into the resonant acoustic mixer, the lithium-ion conductivity of the composite anode active material 10 may be reduced, and when a larger amount of the second solid electrolyte 12 beyond the above range is put into the resonant acoustic mixer, the energy density of the battery may be reduced.

Balls, for example, zirconia (ZrO₂) balls, may be added into the resonant acoustic mixer together with the anode active material and the second solid electrolyte 12. The anode active material and the second solid electrolyte 12, and the balls may be put into the resonant acoustic mixer in a weight ratio of 1:4 to 1:8. Coating efficiency may be increased by adding the balls into the resonant acoustic mixer.

After synthesizing the composite anode active material 10, the anode active material slurry may be prepared by putting the composite anode active material 10 and the first solid electrolyte 20 into a solvent. Thereafter, the anode active material layer for all-solid-state batteries may be formed by applying the anode active material slurry to the anode current collector and then drying the anode active material slurry.

Any solvent commonly used in the process of preparing the anode active material slurry, such as N-methyl-2-pyrrolidone (NMP), may be applied.

The anode current collector is a component that transmits current to the anode active material or receives current from the anode active material during charging and discharging, and the anode current collector may be a plate-shaped substrate having electrical conductivity. Specifically, the anode current collector may have the form of a sheet, a thin film, or foil.

The anode current collector may include a material that does not react with lithium. Specifically, the anode current collector may include at least one selected from the group consisting of nickel (Ni), copper (Cu), stainless steel, and combinations thereof, for example.

The thickness of the anode current collector is not particularly limited, and may be, for example, 1 μm to 500 μm.

Hereinafter, example embodiments of the present disclosure will be described in more detail through the following Examples and Comparative Examples. The following Examples and Comparative Examples serve merely to describe the present disclosure, and are not intended to necessarily limit the scope and spirit of the disclosure.

### TEST EXAMPLE 1

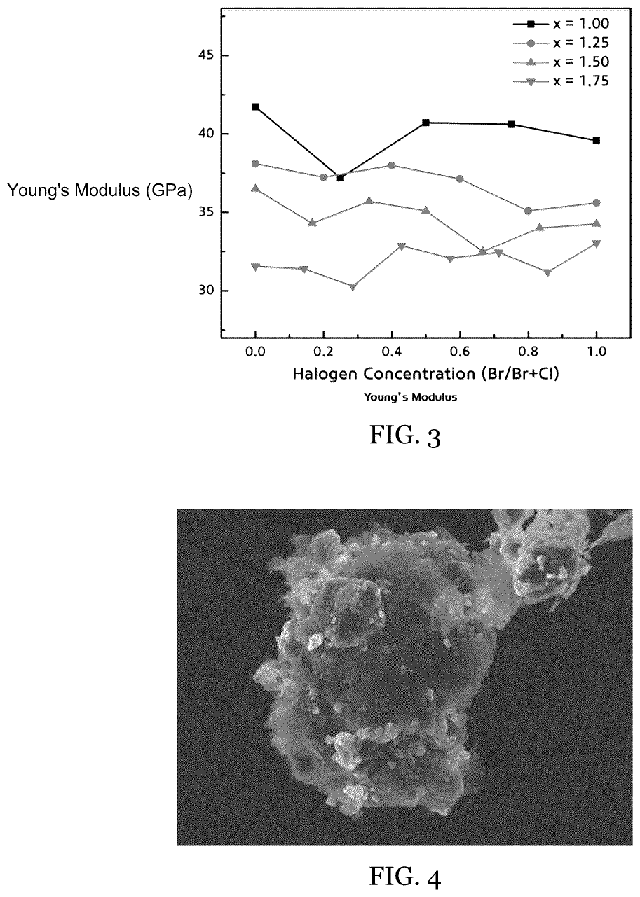

FIG. 3 shows Young's modulus measurement results of argyrodite-type sulfide-based solid electrolytes having various halogen contents. Specifically, solid electrolyte powder having a composition of Li₆PS₅X (X being Br, or Br+Cl) was pressed and processed into rectangular specimens having a designated thickness, and the specimens were mounted on a tensile strength tester to measure Young's modulus thereof.

Referring to FIG. 3, it was confirmed that the Young's modulus decreases as the content of a halogen element with which the argyrodite-type sulfide-based solid electrolyte is doped deceases.

### MANUFACTURING EXAMPLE 1

(a) A Si/C composite was prepared as an anode active material. A sulfide-based solid electrolyte having a Young's modulus (E₁) of 12.8 GPa and lithium-ion conductivity (I₁) of 8.8 mS/cm was prepared as a first solid electrolyte, and a sulfide-based solid electrolyte having a Young's modulus (E₂) of 8.3 GPa and lithium-ion conductivity (I₂) of 5.3 mS/cm was prepared as a second solid electrolyte.

(b) The anode active material and the second solid electrolyte prepared in a powdery form were weighed in a weight ratio of 10:1, and were put into a resonant acoustic mixer (LabRAM1, Resodyn Acoustic Mixers). Additionally, zirconium (ZrO₂) balls were added to the resonant acoustic mixer so that a weight ratio of the anode active material and the second solid electrolyte in the powdery form to the zirconium (ZrO₂) balls was 1:4.

Thereafter, a composite anode active material having a core-shell structure including the silicon-based anode active material as cores and the second solid electrolyte configured to coat at least a portion of the silicon-based anode active material was obtained by mixing the anode active material and the second solid electrolyte together with the zirconium (ZrO₂) balls under conditions of about 50 G for 5 minutes. The temperature of the composite anode active material was measured to be about 30° C.

(c) An anode active material slurry was prepared by putting the composite anode active material and the prepared first solid electrolyte into N-methyl-2-pyrrolidone (NMP) as an organic solvent and mixing the same. Thereafter, an anode active material layer was formed by applying the anode active material slurry to Ni foil as an anode current collector and drying the anode active material slurry, and thereby, an anode including the anode current collector and the anode active material layer stacked on the anode current collector was obtained.

### MANUFACTURING EXAMPLE 2

An anode was obtained through the same process as in Manufacturing Example 1, except that a sulfide-based solid electrolyte having a Young's modulus (E₁) of 26.9 GPa and lithium-ion conductivity (I₁) of 3.9 mS/cm was used as a first solid electrolyte, and a sulfide-based solid electrolyte having a Young's modulus (E₂) of 11.0 GPa and lithium-ion conductivity (I₂) of 5.2 mS/cm was used as a second solid electrolyte.

### COMPARATIVE MANUFACTURING EXAMPLE 1

An anode was obtained through the same process as in Manufacturing Example 1, except that the second solid electrolyte was not put into the resonant acoustic mixer in step (b) of Manufacturing Example 1.

### COMPARATIVE MANUFACTURING EXAMPLE 2

An anode was obtained through the same process as in Manufacturing Example 1, except that a sulfide-based solid electrolyte having a Young's modulus (E₂) of 26.9 GPa and lithium-ion conductivity (I₂) of 3.9 mS/cm was used as a second solid electrolyte.

### COMPARATIVE MANUFACTURING EXAMPLE 3

An anode was obtained through the same process as in Manufacturing Example 2, except that a sulfide-based solid electrolyte having a Young's modulus (E₂) of 8.3 GPa and lithium-ion conductivity (I₂) of 5.3 mS/cm was used as a second solid electrolyte.

### COMPARATIVE MANUFACTURING EXAMPLE 4

An anode was obtained through the same process as in Manufacturing Example 2, except that a sulfide-based solid electrolyte having a Young's modulus (E₂) of 16.5 GPa and lithium-ion conductivity (I₂) of 9.1 mS/cm was used as a second solid electrolyte.

### COMPARATIVE MANUFACTURING EXAMPLE 5

To investigate the effect of a type of mixer on the electrochemical properties of a composite anode active material, a composite anode active material and an anode including the same were manufactured using a paint shaker instead of the resonant acoustic mixer.

Specifically, (b) an anode active material and a second solid electrolyte prepared in a powdery form were weighed in a weight ratio of 10:1, and were put into a paint shaker (YJ-2A02, SH sigma). Additionally, zirconium (ZrO₂) balls were added to the paint shaker so that a weight ratio of the anode active material and the second solid electrolyte in the powdery form to the zirconium (ZrO₂) balls was 1:4.

Thereafter, the composite anode active material having a core-shell structure including a silicon-based anode active material as cores and the second solid electrolyte configured to coat at least a portion of the silicon-based anode active material was obtained by mixing the anode active material and the second solid electrolyte together with the zirconium (ZrO₂) balls under conditions of about 50 G for 30 minutes. The anode was manufactured through the same process as in Manufacturing Example 1, except that the temperature of the composite anode active material was measured to be about 90° C.

### COMPARATIVE MANUFACTURING EXAMPLE 6

To investigate the effect of a type of mixer on the electrochemical properties of a composite anode active material, a composite anode active material and an anode including the same were manufactured using a Thinky mixer instead of the resonant acoustic mixer.

Specifically, (b) an anode active material and a second solid electrolyte prepared in a powdery form were weighed in a weight ratio of 10:1, and were put into a Thinky mixer (ARE-500, THINKY). Additionally, zirconium (ZrO₂) balls were added to the Thinky mixer so that a weight ratio of the anode active material and the second solid electrolyte in the powdery form to the zirconium (ZrO₂) balls was 1:4.

Thereafter, the composite anode active material having a core-shell structure including a silicon-based anode active material as cores and the second solid electrolyte configured to coat at least a portion of the silicon-based anode active material was obtained by mixing the anode active material and the second solid electrolyte together with the zirconium (ZrO₂) balls under conditions of about 50 G for 10 minutes. The anode was manufactured through the same process as in Manufacturing Example 1, except that the temperature of the composite anode active material was measured to be about 55° C.

The conditions of the composite anode active materials used in the process of obtaining the anodes according to the above Manufacturing Examples and Comparative Manufacturing Examples are set forth in Table 1 below.

TABLE 1

| | | | | | Anode active material | |
|---|---|---|---|---|---|---|
| | First solid electrolyte | | Second solid electrolyte | | layer | |
| Example | E₁ (GPa) | I₁ (mS/cm) | E₂ (GPa) | I₂ (mS/cm) | (E₁/E₂) | (I₁/I₂) |
| Manufacturing | 21.8 | 8.8 | 8.3 | 5.3 | 2.63 | 1.67 |
| example 1 | | | | | | |
| Manufacturing | 26.9 | 3.9 | 11.0 | 5.2 | 2.45 | 0.75 |
| example 2 | | | | | | |
| Comp. | 21.8 | 8.8 | Uncoated | uncoated | — | — |
| manufacturing | | | | | | |
| example 1 | | | | | | |
| Comp. | 21.8 | 8.8 | 26.9 | 3.9 | 0.81 | 2.26 |
| manufacturing | | | | | | |
| example 2 | | | | | | |
| Comp. | 26.9 | 3.9 | 8.3 | 5.3 | 3.24 | 0.74 |
| manufacturing | | | | | | |
| example 3 | | | | | | |
| Comp. | 26.9 | 3.9 | 16.5 | 9.1 | 1.63 | 0.42 |
| manufacturing | | | | | | |
| example 4 | | | | | | |
| Comp. | 21.8 | 8.8 | 8.3 | 5.3 | 2.63 | 1.67 |
| manufacturing | | | | | | |
| example 5 | | | | | | |
| Comp. | 26.9 | 3.9 | 11.0 | 5.2 | 2.45 | 0.75 |
| manufacturing | | | | | | |
| example 6 | | | | | | |

### TEST EXAMPLE 2—SEM AND EDS ANALYSIS OF COMPOSITE ANODE ACTIVE MATERIALS

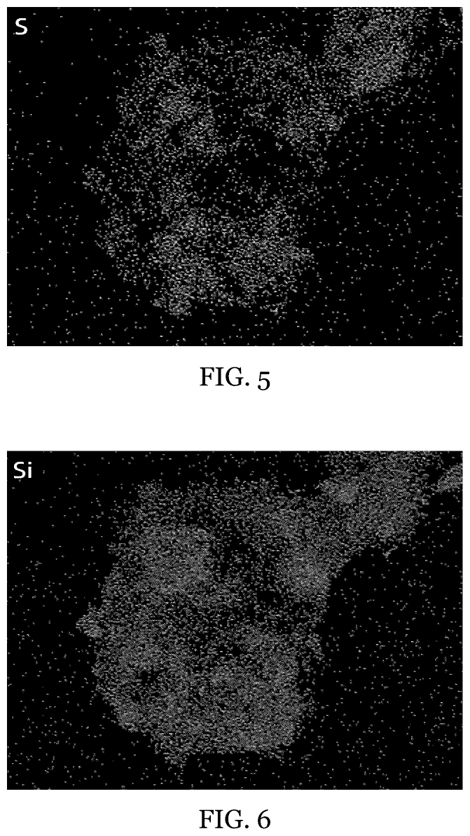

In the process of manufacturing the anode according to Manufacturing Example 1, the composite anode active material synthesized through step (b) was photographed with a scanning electron microscope (SEM), and the photograph of the composite anode active material is shown in FIG. 4. Further, mapping for sulfur (S) and silicon (Si) in the same composite anode active material was performed using energy dispersive spectroscopy (EDS), and analysis results thereof are shown in FIGS. 5 and 6, respectively.

Referring to FIGS. 5 and 6, both sulfur (S) and silicon (Si) were observed in the synthesized composite anode active material, and thereby, it was confirmed that at least a portion of the surface of the silicon-based anode active material was properly coated with the second solid electrolyte.

### EXAMPLE 1

(a) The anode according to Manufacturing Example 1, Li₆PS₅Cl which is a sulfide-based solid electrolyte having an argyrodite-type crystal structure, and a lithium (Li) thin film were prepared.

(b) A compressed battery, which is an all-solid-state battery, was manufactured by sequentially stacking the anode, a solid electrolyte layer including Li₆PS₅Cl, i.e., the sulfide-based solid electrolyte having the argyrodite-type crystal structure, and the lithium (Li) thin film and then pressing the same.

### EXAMPLE 2

A compressed battery was manufactured through the same process as in Example 1, except that the anode according to Manufacturing Example 2 was used.

### COMPARATIVE EXAMPLE 1

A compressed battery was manufactured through the same process as in Example 1, except that the anode according to Comparative Manufacturing Example 1 was used.

### COMPARATIVE EXAMPLE 2

A compressed battery was manufactured through the same process as in Example 1, except that the anode according to Comparative Manufacturing Example 2 was used.

### COMPARATIVE EXAMPLE 3

A compressed battery was manufactured through the same process as in Example 1, except that the anode according to Comparative Manufacturing Example 3 was used.

### COMPARATIVE EXAMPLE 4

A compressed battery was manufactured through the same process as in Example 1, except that the anode according to Comparative Manufacturing Example 4 was used.

### COMPARATIVE EXAMPLE 5

A compressed battery was manufactured through the same process as in Example 1, except that the anode according to Comparative Manufacturing Example 5 was used.

### COMPARATIVE EXAMPLE 6

A compressed battery was manufactured through the same process as in Example 1, except that the anode according to Comparative Manufacturing Example 6 was used.

### TEST EXAMPLE 3—OUTPUT EVALUATION AND DURABILITY EVALUATION OF COMPRESSED BATTERIES

To measure durabilities of the compressed batteries manufactured according to the above Examples and Comparative Examples, output evaluation of the compressed batteries manufactured according to the above Examples and Comparative Examples was conducted by performing charging and discharging of the compressed batteries twice under conditions set forth in Table 2 below, and durability evaluation of the compressed batteries manufactured according to the above Examples and Comparative Examples was conducted by performing charging and discharging of the compressed batteries 50 times under conditions set forth in Table 2 below.

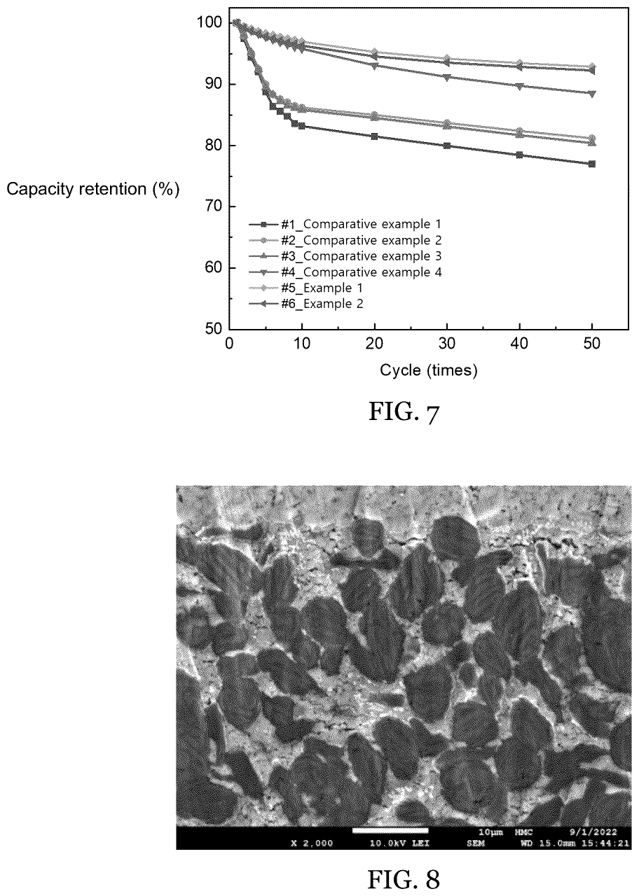

Results thereof are shown in Table 2 and FIG. 7.

TABLE 2

| | Output evaluation | | Durability |
|---|---|---|---|
| | Discharge | Discharge | evaluation |
| | capacity | capacity | 0.2 C |
| Example | (mAh/g) at 0.1 C | (mAh/g) at 0.33 C | (52^{nd}/3^{rd})(%) |
| Example 1 | 186.9 | 168.7 | 92.9 |
| Example 2 | 192.2 | 175.3 | 92.2 |
| Comp. example | 169.0 | 149.0 | 77.0 |
| 1 | | | |
| Comp. example | 168.1 | 145.9 | 81.2 |
| 2 | | | |
| Comp. example | 178.8 | 161.1 | 80.4 |
| 3 | | | |
| Comp. example | 169.7 | 150.1 | 88.5 |
| 4 | | | |

Referring to Table 2, it was confirmed that output and durability characteristics of the compressed batteries according to Examples 1 and 2 in which the ratio E₁/E₂ of the Young's modulus E₁ of the first solid electrolyte to the Young's modulus E₂ of the second solid electrolyte satisfies 1.5≤E₁/E₂≤3.0, and simultaneously the ratio I₁/I₂ of the lithium-ion conductivity I₁ of the first solid electrolyte to the lithium-ion conductivity I₂ of the second solid electrolyte satisfies 0.5≤I₁/I₂≤2.0 were superior to those of the compressed batteries according to Comparative Examples.

### TEST EXAMPLE 4—EVALUATION OF STRUCTURES OF ANODE ACTIVE MATERIAL LAYERS AFTER DURABILITY EVALUATION

After durability evaluation was conducted according to Test Example 3, the anodes were separated from the compressed batteries of Example 1 and Comparative Example 4, and were photographed with a scanning electron microscope (SEM). Obtained photographs thereof are shown in FIGS. 8 and 9, respectively.

Referring to FIGS. 8 and 9, in the anode of Example 1 including the anode active material layer according to the preset disclosure, no noticeable cracks or voids were observed between the composite anode active material and the first solid electrolyte. On the other hand, in case of the anode of Comparative Example 4, it was confirmed that cracks were formed at the interface between the composite anode active material and the first solid electrolyte. Therethrough, it may be predicted that the anode of Comparative Example 4 will have high interfacial resistance.

### TEST EXAMPLE 5—CHANGES IN ELECTROCHEMICAL PROPERTIES DEPENDING TYPE OF MIXER

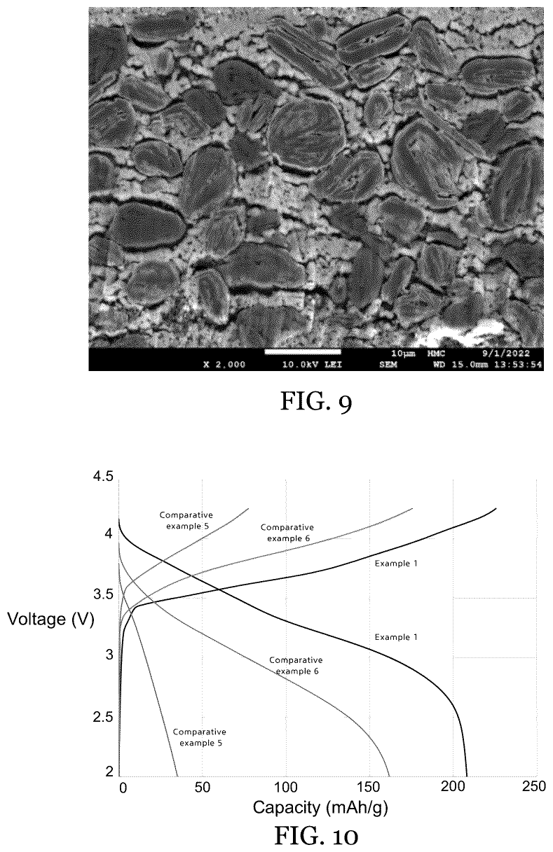

To find out changes in electrochemical properties depending on the type of mixer, electrochemical evaluation was conducted by performing initial charging and discharging of the compressed batteries manufactured according to Example 1, Comparative Example 5 and Comparative Example 6. Results thereof are shown in FIG. 10.

Referring to FIG. 10, it was confirmed that the compressed battery of Example 1, in which mixing was performed for about 5 minutes using the resonant acoustic mixer, exhibited the best initial charge and discharge characteristics. On the other hand, it was confirmed that the compressed battery manufactured using the paint shaker requiring a long composite process time and a high temperature of the anode active material after mixing exhibited significantly low initial charge and discharge capacities.

This is expected because when the temperature of the anode active material exceeds 40° C. during the mixing process, a side reaction occurs between carbon in the anode active material and the solid electrolyte, and thus causes deterioration of the anode active material.

As is apparent from the above description, an anode active material layer according to the present disclosure controls a ratio E₁/E₂ of the Young's modulus E₁ of a first solid electrolyte to the Young's modulus E₂ of a second solid electrolyte within 1.5≤E₁/E₂≤3.0, and may thus suppress increase in interfacial resistance between the first solid electrolyte and the second electrolyte due to a change in the volume of a silicon-based anode active material.

Further, the anode active material layer according to the present disclosure controls a ratio I₁/I₂ of the lithium-ion conductivity I₁ of the first solid electrolyte to the lithium-ion conductivity I₂ of the second solid electrolyte within 0.5≤I₁/I₂≤2.0, and may thus suppress increase in the interfacial resistance between the first solid electrolyte and the second electrolyte due to a difference in lithium-ion conductivity therebetween.

In addition, in a manufacturing method of composite anode active material layer according to an embodiment of the present disclosure, a composite anode active material can be prepared at a low temperature using a resonant acoustic mixer, and may thus suppress a side reaction between the anode active material and the solid electrolyte.

The advantages of an embodiment of the present disclosure are not limited to the above-mentioned advantages. The advantages of the present disclosure can be understood to include all advantages that may be inferred from the above description.

The present disclosure has been described in detail with reference to example embodiments thereof. However, it can be appreciated by those skilled in the art that changes may be made in these example embodiments without departing from the principles and spirit of the disclosure, the scope of which is defined in the appended claims and their equivalents.

What is claimed is:

1. An anode active material layer for all-solid-state batteries, comprising:
a first solid electrolyte; and
a composite anode active material having a core-shell structure, wherein the composite anode active material comprises
cores comprising a silicon-based active material, and
shells configured to coat at least a portion of a surface of the cores, and wherein the shells comprise a second solid electrolyte,
wherein a ratio (E₁/E₂) of a first Young's modulus (E₁) of the first solid electrolyte to a second Young's modulus (E₂) of the second solid electrolyte satisfies 1.5≤E₁/E₂≤3.0.

2. The layer of claim 1, wherein a ratio (I₁/I₂) of a first lithium-ion conductivity (I₁) of the first solid electrolyte to a second lithium-ion conductivity (I₂) of the second solid electrolyte satisfies 0.5≤I₁/I₂≤2.0.

3. The layer of claim 1, wherein the first solid electrolyte comprises a sulfide-based solid electrolyte.

4. The layer of claim 1, wherein the second solid electrolyte comprises a sulfide-based solid electrolyte.

5. The layer of claim 1, wherein the silicon-based active material comprises one selected from the group consisting of silicon particles, silicon oxide, a silicon alloy, and combinations thereof.

6. The layer of claim 1, wherein the silicon-based active material comprises a carbon-based material.

7. A manufacturing method of an anode active material layer for all-solid-state batteries, comprising:
synthesizing a composite anode active material by putting an anode active material and a second solid electrolyte into a mixer and then mixing the anode active material and the second solid electrolyte;
preparing an anode active material slurry by mixing the composite anode active material and a first solid electrolyte; and
forming the anode active material layer by applying the anode active material slurry to an anode current collector and then drying the anode active material slurry,
wherein a temperature of the composite anode active material after mixing the anode active material and the second solid electrolyte is 40° C. or lower.

8. The manufacturing method of claim 7, wherein the mixer comprises a resonant acoustic mixer (RAM).

9. The manufacturing method of claim 7, wherein the anode active material and the second solid electrolyte are mixed for 2 minutes to 15 minutes.

10. The manufacturing method of claim 7, wherein the anode active material and the second solid electrolyte are put into the mixer in a weight ratio of 10:1 to 7:3.

11. A manufacturing method of an anode active material layer for all-solid-state batteries, comprising:
synthesizing a composite anode active material by putting an anode active material and a second solid electrolyte into a mixer and then mixing the anode active material and the second solid electrolyte at a mixing temperature of 40° C. or lower;
preparing an anode active material slurry by mixing the composite anode active material and a first solid electrolyte; and
forming the anode active material layer by applying the anode active material slurry to an anode current collector and then drying the anode active material slurry.

12. The manufacturing method of claim 11, wherein the mixer comprises a resonant acoustic mixer (RAM).

13. The manufacturing method of claim 11, wherein the anode active material and the second solid electrolyte are mixed for 2 minutes to 15 minutes.

14. The manufacturing method of claim 11, wherein the anode active material and the second solid electrolyte are put into the mixer in a weight ratio of 10:1 to 7:3.

15. The manufacturing method of claim 11, wherein the preparing of the anode active material slurry is performed at a preparing temperature of 40° C. or lower.

16. The manufacturing method of claim 15, wherein the applying of the anode active material slurry to the anode current collector is performed at an applying temperature of 40° C. or lower.

17. The manufacturing method of claim 16, wherein the drying of the anode active material slurry is performed at a drying temperature of 40° C. or lower.
